(19) United States
(12) Patent Application Publication
(10) Pub. No.: US 2017/0127363 A1
(43) Pub. Date: May 4, 2017

(54) TRANSMISSION SYSTEM, WIRELESS DEVICE, AND SYNCHRONIZATION ESTABLISHMENT METHOD

(71) Applicant: FUJITSU LIMITED, Kawasaki-shi (JP)

(72) Inventors: Kazushi Tamamoto, Kawasaki (JP); SHIGEAKI KAWAMATA, Sagamihara (JP); NOBUYUKI FUKUDA, Yokohama (JP); Toshihiro Kobayashi, Yokohama (JP)

(73) Assignee: FUJITSU LIMITED, Kawasaki-shi (JP)

(21) Appl. No.: 15/271,984

(22) Filed: Sep. 21, 2016

(30) Foreign Application Priority Data
Oct. 30, 2015 (JP) 2015-214356

(51) Int. Cl. H04W 56/00; H04W 72/04

(52) U.S. Cl. CPC H04W 56/001; H04W 72/04; H04B 10/25752

(57) ABSTRACT

A radio equipment controller (REC) includes a transmission serializer/deserializer (SERDES), a reception SERDES, and an adjustment unit. The adjustment unit adjusts a transmission timing of a downlink frame to be transmitted from the transmission SERDES in the REC so that the transmission timing of the downlink frame from an antenna of radio equipment (RE) becomes a predetermined timing after synchronization of a downlink and an uplink is established. The RE includes a transmission SERDES, a reception SERDES, and a control unit. The control unit causes the transmission SERDES in the RE to start transmitting an uplink frame after the synchronization of the downlink is established with the REC. The control unit also causes the transmission SERDES in the RE to maintain a transmission timing of the uplink frame, even if a synchronization loss of the downlink is detected due to adjustment of the transmission timing of the downlink frame.

### CROSS-REFERENCE TO RELATED APPLICATION

This application is based upon and claims the benefit of priority of the prior Japanese Patent Application No. 2015-214356, filed on Oct. 30, 2015, the entire contents of which are incorporated herein by reference.

### FIELD

The embodiment discussed herein is related to a transmission system, a wireless device, and a synchronization establishment method.

### BACKGROUND

A base station system in which a plurality of pieces of radio equipment (RE) are connected to a single radio equipment controller (REC) through a cable such as a coaxial cable or an optical fiber has been known. Communication between the REC and the RE is performed based on a communication standard called common public radio interface (CPRI). In such a base station system, the REC adjusts a timing of a downlink frame to be transmitted to each RE so that a timing of the downlink frame having been wirelessly transmitted to a mobile station from the RE synchronizes at the end of an antenna of each RE.

Because the installation location of each RE is different, the length of an optical fiber cable that connects the REC and the RE differs for each RE. Thus, a transmission delay T12 of the optical fiber cable that connects the REC and the RE differs for each RE. In addition, because the internal configuration and the processing capacity of the RE differ for each vendor, a processing time T2a from when the RE receives a downlink frame to when the RE transmits the received downlink frame from the antenna differs for each RE. Hence, the transmission timing of the downlink frame to be transmitted from the REC to each RE is adjusted based on T12 and T2a.

In the timing adjustment of the downlink frame in the REC, synchronization of the downlink and the uplink is established between the REC and the RE, when the REC first transmits a downlink frame to the RE at a certain timing. The RE then transmits the downlink frame having received from the REC as an uplink frame to the REC after a predetermined time (hereinafter, referred to as Toffset) has passed. The REC then measures a round-trip time T14 during which a downlink frame having been transmitted to the RE returns as an uplink frame. The REC also calculates T12 based on Toffset and T14. The REC then changes the timing of the downlink frame, based on T12 and T2a.

When the timing of the downlink frame is changed, the RE loses a synchronization signal having been added to the downlink frame, thereby detecting a downlink synchronization loss. When the downlink synchronization loss is detected, the RE stops transmitting the uplink frame. When the synchronization of the downlink is reestablished, the RE starts transmitting the uplink frame again. The REC then measures T14 again, and recalculates T12, based on the re-measured T14 and Toffset. The REC completes the timing adjustment of the downlink frame when a difference between a timing at which T12 and T2a have passed from the transmission timing of the downlink frame and a reference timing is less than a predetermined value. Examples of such techniques are disclosed in Japanese National Publication of International Patent Application No. 2015-501601, Japanese Laid-open Patent Publication No. 2015-053547, and Japanese Laid-open Patent Publication No. 2012-095057.

When a downlink synchronization loss is detected, the RE stops transmitting the uplink frame, by stopping a serializer/deserializer (SERDES) that transmits the uplink frame. When the synchronization of the downlink is reestablished, the RE starts transmitting the uplink frame again, by activating the SERDES. In this case, in the uplink frame in which the transmission is restarted, a delay error due to the SERDES occurs. Thus, when T14 is measured again after the REC has changed the timing of the downlink frame, the value of T14 may change due to the delay error of the SERDES. Hence, T12 that is calculated based on the re-measured T14 may also change. If a difference between the timing at which T12 and T2a have passed from the transmission timing of the downlink frame and the reference timing is equal to or more than the predetermined value, the timing adjustment of the downlink frame will be performed again. Consequently, the timing adjustment of the downlink frame may take a long time, thereby causing a delay in starting the RE.

### SUMMARY

According to an aspect of an embodiment, a transmission system includes a wireless control device and a wireless device that is connected to the wireless control device through a cable. The wireless control device includes a first transmission unit, a first reception unit, and an adjustment unit. The first transmission unit transmits a downlink frame through the cable in a downlink from the wireless control device to the wireless device. The first reception unit receives an uplink frame from the wireless device through the cable in an uplink from the wireless device to the wireless control device. The adjustment unit adjusts a transmission timing of the downlink frame to be transmitted from the first transmission unit so that the transmission timing of the downlink frame from an antenna of the wireless device becomes a predetermined timing after synchronization of the downlink and the uplink is established with the wireless device. The wireless device includes a second reception unit, a second transmission unit, and a control unit. The second reception unit receives the downlink frame from the wireless control device through the cable in the downlink. The second transmission unit transmits the uplink frame to the wireless control device through the cable in the uplink. The control unit causes the second transmission unit to start transmitting the uplink frame after the synchronization of the downlink is established with the wireless control device. After causing the second transmission unit to start transmitting the uplink frame, the control unit of the wireless device causes the second transmission unit to maintain a transmission timing of the uplink frame, even when a synchronization loss of the downlink is detected due to adjustment of the transmission timing of the downlink frame.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a transmission system;

FIG. 2 is a block diagram illustrating an example of an REC and RE;

FIG. 3 is a diagram illustrating an example of a timing of a downlink frame and an uplink frame;

FIG. 4 is a diagram illustrating an example of data stored in a storage unit;

FIG. 5 is a diagram illustrating an example of an operation of the transmission system when the first synchronization is established;

FIG. 6 is a diagram illustrating an example of an operation of a conventional transmission system when the timing of the downlink frame is changed;

FIG. 7 is a diagram illustrating an example of an operation of a transmission system of the present embodiment when the timing of the downlink frame is changed;

FIG. 8 is a diagram illustrating an example of an operation of the transmission system of the present embodiment when the timing of the downlink frame is changed;

FIG. 9 is a flowchart illustrating an example of a timing adjustment process in the REC;

FIG. 10 is a flowchart illustrating an example of the timing adjustment process in the RE;

FIG. 11 is a diagram for explaining a transmission timing of the uplink frame;

FIG. 12 is a diagram for explaining a transmission timing of the uplink frame;

FIG. 13 is a diagram illustrating an example of hardware of a communication device that implements the REC; and

FIG. 14 is a diagram illustrating an example of hardware of a communication device that implements the RE.

### DESCRIPTION OF EMBODIMENT

Preferred embodiments of the present invention will be explained with reference to accompanying drawings. It is to be understood that the transmission system, the wireless device, and the synchronization establishment method disclosed in the present application are not limited to the following embodiment.

Transmission System 10

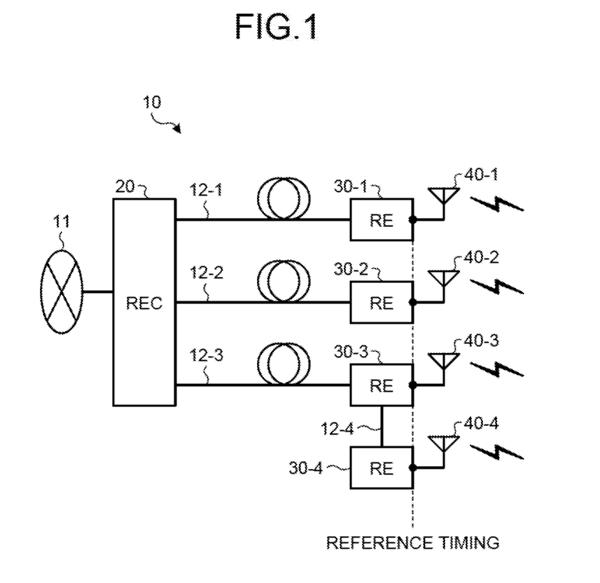

FIG. 1 is a diagram illustrating an example of a transmission system 10. The transmission system 10 includes an REC 20 and a plurality of pieces of RE 30-1 to RE 30-4. The RE 30-1 includes an antenna 40-1 and the RE 30-2 includes an antenna 40-2. The RE 30-3 includes an antenna 40-3 and the RE 30-4 includes an antenna 40-4. The RE 30-1 is connected to the REC 20 through a cable 12-1, and the RE 30-2 is connected to the REC 20 through a cable 12-2. The RE 30-3 is connected to the REC 20 through a cable 12-3 and the RE 30-4 is connected to the RE 30-3 through a cable 12-4.

In the following, the RE 30-1 to the RE 30-4 may be collectively referred to as an RE 30, without distinguishing one from another, and the antenna 40-1 to the antenna 40-4 may be collectively referred to as an antenna 40 without distinguishing one from another. In the following, the cable 12-1 to the cable 12-4 may be collectively referred to as a cable 12 without distinguishing one from another. Each cable 12 is an optical fiber cable, and communication between the REC 20 and each RE 30 is performed based on the communication standard called the CPRI, for example. The REC 20 is an example of a wireless control device, and each RE 30 is an example of a wireless device.

In the transmission system 10 illustrated in FIG. 1, the REC 20 creates a downlink frame based on data received over a core network 11. The REC 20 then transmits the created downlink frame to the RE 30 through the cable 12. The REC 20 also transmits data on an uplink frame received from the RE 30 through the cable 12 over the core network 11. The RE 30 wirelessly transmits the downlink frame received from the REC 20 through the cable 12, through the antenna 40. The RE 30 creates an uplink frame based on a signal received through the cable 12. The RE 30 then transmits the created uplink frame to the REC 20 through the cable 12.

The REC 20 also adjusts the timing of the downlink frame to be transmitted to each RE 30 so that the timing of the downlink frame, which is wirelessly transmitted from the RE 30, becomes a reference timing at the end of the antenna 40 of each RE 30. More specifically, the REC 20 calculates a transmission delay T12 of the cable 12, based on a round-trip time of a signal having been transmitted to the RE 30, for each RE 30. The REC 20 also acquires a processing time T2a that is from when the RE 30 has received a downlink frame to when the RE 30 transmits the received downlink frame from the antenna 40, from the RE 30. T2a is a value unique to each RE 30, and is stored in each RE 30 in advance. The REC 20 then adjusts the transmission timing of the downlink frame to a timing going back from the reference timing by T12 and T2a. In this manner, the downlink frame is wirelessly transmitted from the antenna 40 of each RE 30 at the reference timing.

In the following, a process of adjusting the timing of the downlink frame to be transmitted to the RE 30 so that the timing of the downlink frame, which is to be wirelessly transmitted from the RE 30, becomes the reference timing at the end of the antenna 40 of each RE 30 is referred to as a timing adjustment process. Also in the following, a transmission path from the REC 20 to the RE 30 is referred to as a downlink, and a frame to be transmitted in the downlink is referred to as a downlink frame. A transmission path from the RE 30 to the REC 20 is referred to as an uplink, and a frame to be transmitted in the uplink is referred to as an uplink frame.

Configurations of the REC 20 and the RE 30

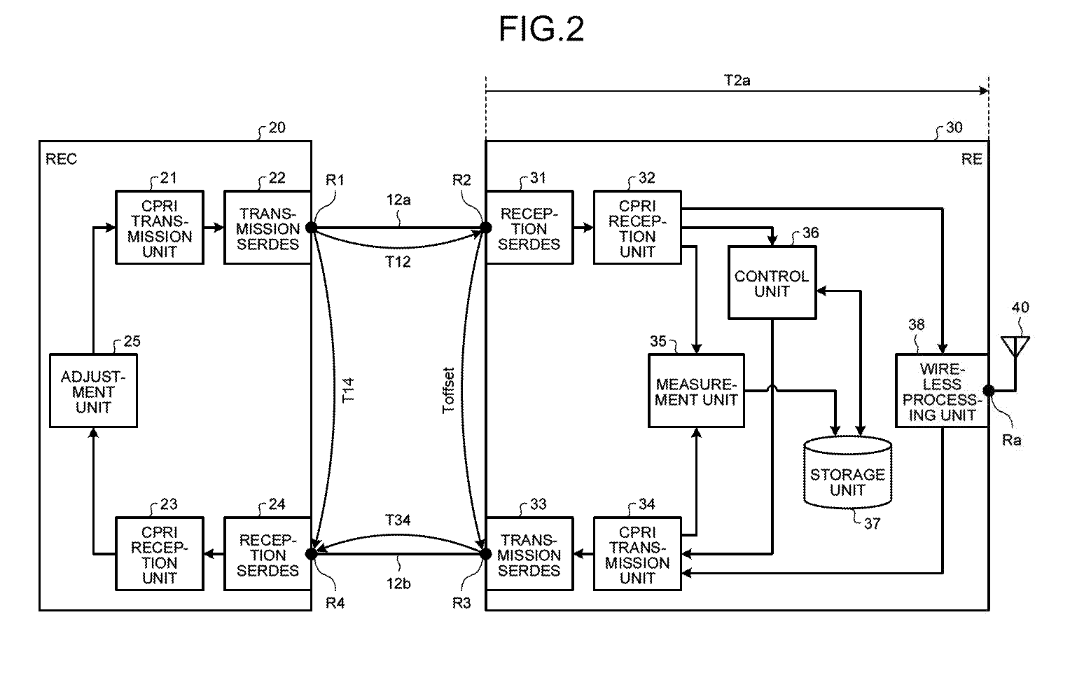

FIG. 2 is a block diagram illustrating an example of the REC 20 and the RE 30. In the example of FIG. 2, the REC 20 and the RE 30 are connected through a cable 12a and a cable 12b. The downlink frame to be transmitted from the REC 20 to the RE 30 is transmitted to the RE 30 through the cable 12a. The uplink frame to be transmitted from the RE 30 to the REC 20 is transmitted to the REC 20 through the cable 12b. The REC 20 and the RE 30 may also be connected through a single cable 12, and both the downlink frame and the uplink frame may be transmitted through the cable 12.

Each of the downlink frame and the uplink frame transmitted and received between the REC 20 and the RE 30 is referred to as a hyperframe, for example. The hyperframe includes a header and a payload, and the length Tf of one frame is 66 microseconds, for example. A synchronization signal is added at the beginning of the header. The header includes information such as a hyper frame number (HFN), a protocol version, and a bit rate.

As illustrated in FIG. 2, a connection point between the REC 20 and the cable 12a is defined as R1, a connection point between the RE 30 and the cable 12a is defined as R2, a connection point between the RE 30 and the cable 12b is defined as R3, and a connection point between the REC 20 and the cable 12b is defined as R4. In addition, a connection point between the RE 30 and the antenna 40 is defined as Ra. A transmission delay of the cable 12a is defined as T12, and a transmission delay of the cable 12b is defined as T34. A time from when a downlink frame is received at the connection point R2 to when an uplink frame corresponding to the downlink frame is transmitted from the connection point R3 is defined as Toffset. A round-trip time from when a downlink frame is transmitted from the connection point R1 to when an uplink frame corresponding to the downlink frame is transmitted from the RE 30 and received at the connection point R4 is defined as T14. A processing time from when a downlink frame is received at the connection point R2 to when the downlink frame is output to the antenna 40 from the connection point Ra is defined as T2a.

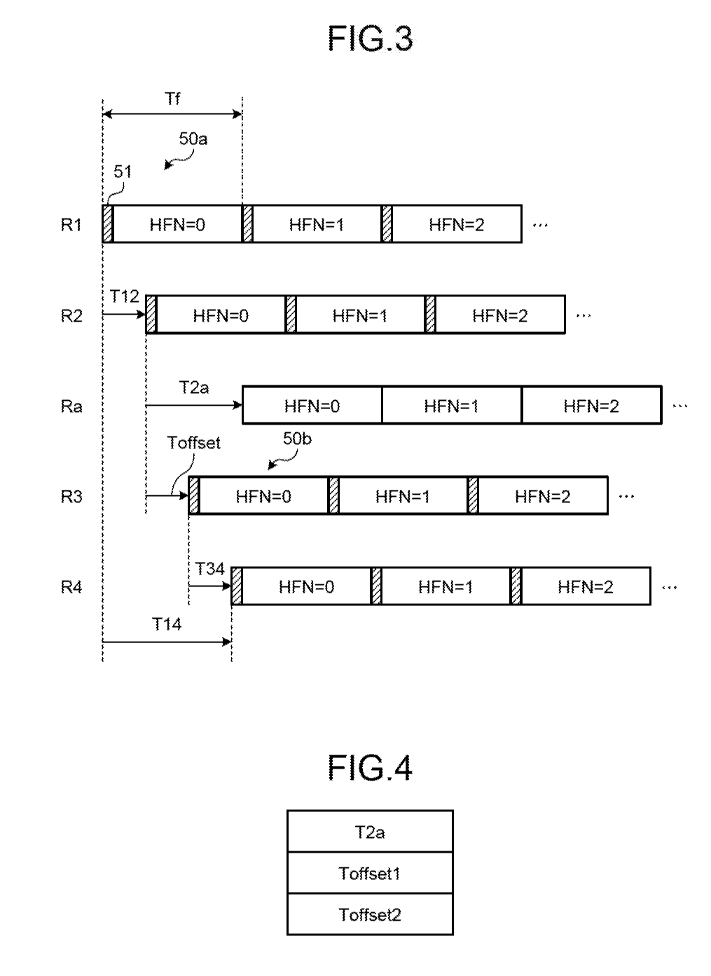

For example, FIG. 3 illustrates a procedure from when a downlink frame is transmitted at the connection point R1 to when an uplink frame corresponding to the downlink frame is transmitted from the RE 30 and received at the connection point R4. FIG. 3 is a diagram illustrating an example of a timing of a downlink frame and an uplink frame. As illustrated in FIG. 3, for example, a period Tf of one frame of a downlink frame 50a and an uplink frame 50b is 66 microseconds, and a synchronization signal 51 is added at the beginning of the downlink frame 50a and the uplink frame 50b.

For example, as illustrated in FIG. 3, the downlink frame 50a is transmitted from the connection point R1 every Tf. The downlink frame 50a that is transmitted from the connection point R1 is transmitted through the cable 12a, and is received at the connection point R2 after T12 has passed. The downlink frame 50a that is received at the connection point R2 is transmitted from the connection point Ra through the antenna 40 after T2a has passed. In addition, the downlink frame 50a that is received at the connection point R2 is transmitted from the connection point R3 as the uplink frame 50b after Toffset has passed. The uplink frame 50b that is transmitted from the connection point R3 is transmitted through the cable 12b, and is received at the connection point R4 after T34 has passed. The downlink frame 50a that is transmitted from the connection point R1 is received at the connection point R4 as the uplink frame 50b after T14 has passed.

Configuration of the REC 20

For example, as illustrated in FIG. 2, the REC 20 includes a CPRI transmission unit 21, a transmission SERDES 22, a CPRI reception unit 23, a reception SERDES 24, and an adjustment unit 25. The CPRI transmission unit 21 creates a downlink frame using data output from a processing unit and the CPRI transmission unit 21 in the REC 20. The CPRI transmission unit 21 then outputs the created downlink frame to the transmission SERDES 22 at a timing instructed by the adjustment unit 25.

The transmission SERDES 22 converts the downlink frame created by the CPRI transmission unit 21 into a serial signal from a parallel signal. The transmission SERDES 22 then converts the converted downlink frame, which is an electric signal, into an optical signal, and transmits the resultant signal to the cable 12a from the connection point R1.

The reception SERDES 24 receives an uplink frame at the connection point R4 through the cable 12b, and converts the received uplink frame, which is an optical signal, into an electric signal. The reception SERDES 24 then converts the converted uplink frame, which is a serial signal, into a parallel signal, and outputs the resultant signal to the CPRI reception unit 23.

The CPRI reception unit 23 determines whether synchronization of the uplink is established based on a synchronization signal having been added at the beginning of the uplink frame that is output from the reception SERDES 24. For example, the CPRI reception unit 23 determines that the synchronization of the uplink is established when a synchronization signal is successfully detected four consecutive times. The CPRI reception unit 23 then determines whether synchronization of the CPRI link is established, by using data included in the uplink frame having been output from the reception SERDES 24. For example, the CPRI reception unit 23 determines that the synchronization of the CPRI link is established when information such as a protocol version and a bit rate included in the header of the uplink frame is detected as predetermined information after the synchronization of the uplink has been established.

The CPRI reception unit 23 then outputs the uplink frame having been output from the reception SERDES 24 to the adjustment unit 25 and the processing unit in the REC 20 after the synchronization of the CPRI link has been established with the RE 30.

The CPRI reception unit 23 also notifies the adjustment unit 25 of an uplink synchronization loss when the uplink synchronization loss is detected. For example, the CPRI reception unit 23 detects an uplink synchronization loss when a synchronization signal is not detected three consecutive times, while the synchronization of the uplink is being established.

The adjustment unit 25 adjusts the transmission timing of the downlink frame, which is to be instructed to the CPRI transmission unit 21, so that the downlink frame is wirelessly transmitted from the antenna 40 of the RE 30 at the reference timing. More specifically, the adjustment unit 25 measures the round-trip time T14 from when a downlink frame is transmitted from the connection point R1 to when an uplink frame including the same frame number as the frame number included in the downlink frame is received at the connection point R4.

For example, the adjustment unit 25 then transmits the downlink frame including an RE device configuration information request that is a message of layer 3 to the RE 30 via the CPRI transmission unit 21. For example, the adjustment unit 25 then receives the uplink frame including an RE device configuration information response that is a message of layer 3 from the RE 30 via the CPRI reception unit 23. The RE device configuration information response includes information on Toffset and T2a.

For example, the adjustment unit 25 calculates the transmission delay T12 of the cable 12a by using the following formula (1).

T12=(T14−Toffset1)/2 (1)

In formula (1) above, Toffset1 is a value of Toffset held in the RE 30 as an initial value, and a value of Toffset before the transmission timing of the downlink frame is changed. Toffset1 is an example of a first time. In formula (1) above, it is assumed that the transmission delay T12 of the cable 12a and the transmission delay T34 of the cable 12b are the same.

For example, the adjustment unit 25 then calculates a delay time Td1 that is a time when a downlink frame having been output from the connection point R1 of the REC 20 is transmitted from the connection point Ra between the RE 30 and the antenna 40, by using the following formula (2).

Td1=T12+T2a (2)

The adjustment unit 25 then calculates a time difference Td2 that is a time difference between a reference timing Tr and a timing at which Td1 has passed from a transmission timing Tc of the current downlink frame at the connection point R1, by using the following formula (3), for example.

Td2=Tr−(Tc+Td1) (3)

The adjustment unit 25 then determines whether the absolute value of Td2 is less than a predetermined threshold ΔT1. If the difference between the transmission timing of the downlink frame having been transmitted from the end of the antenna 40 of the RE 30 and the reference timing Tr is less than the threshold ΔT1, the absolute value of Td2 is less than the predetermined threshold ΔT1. Thus, the adjustment unit 25 transmits the downlink frame including a message indicating that the timing adjustment process has finished to the RE 30 via the CPRI transmission unit 21, without changing the transmission timing of the downlink frame.

By contrast, if the absolute value of Td2 is equal to or more than the predetermined threshold ΔT1, the adjustment unit 25 changes the transmission timing Tc of the current downlink frame at the connection point R1 to a timing shifted by Td2. More specifically, if a timing at which Td1 has passed from the transmission timing Tc of the current downlink frame is a timing temporally before the reference timing Tr, in other words, if Td2 is a positive value, the adjustment unit 25 shifts the transmission timing Tc temporally later by Td2. By contrast, if the timing at which Td1 has passed from the transmission timing Tc of the current downlink frame is a timing temporally after the reference timing Tr, in other words, if Td2 is a negative value, the adjustment unit 25 shifts the transmission timing Tc temporally earlier by Td2. The adjustment unit 25 then instructs the CPRI transmission unit 21 to transmit the downlink frame at the changed timing.

In the present example, if a predetermined condition is satisfied even if the transmission timing of the downlink frame is changed, the RE 30 will not change the transmission timing of the uplink frame. If the transmission timing of the uplink frame is not changed even if the transmission timing of the downlink frame is changed, Toffset will change. For example, the adjustment unit 25 estimates Toffset2e that is an expected value of Toffset and that has changed due to the change in the transmission timing of the downlink frame, by using the following formula (4).

Toffset2e=Toffset1−Td2 (4)

Next, the adjustment unit 25 acquires Toffset2 that is the changed Toffset from the RE 30 after the transmission timing of the downlink frame has been changed. More specifically, the adjustment unit 25 transmits the downlink frame including the RE device configuration information request to the RE 30 via the CPRI transmission unit 21, and receives the uplink frame including the RE device configuration information response from the RE 30 via the CPRI reception unit 23. The adjustment unit 25 then acquires Toffset2 from the RE device configuration information response. Toffset2 is an example of a second time.

Next, the adjustment unit 25 determines whether the absolute value of a difference Td3 that is a difference between the expected value Toffset2e having been estimated by using formula (4) above and Toffset2 obtained from the RE 30 is less than a predetermined threshold ΔT2. If the absolute value of the difference Td3 is less than ΔT2, the adjustment unit 25 transmits a downlink frame including a message indicating that the timing adjustment process has finished to the RE 30 via the CPRI transmission unit 21.

By contrast, if the absolute value of the difference Td3 is equal to or more than ΔT2, the adjustment unit 25 measures T14 again. The adjustment unit 25 then calculates T12 again, by using formula (1) above in which Toffset2 replaces Toffset1. The adjustment unit 25 further calculates Td1 again, by using the recalculated T12 and formula (2) above. The adjustment unit 25 further calculates Td2 again, by using the recalculated Td1 and formula (3) above. The adjustment unit 25 then changes the transmission timing Tc of the current downlink frame again based on the calculated Td2. The adjustment unit 25 repeats the above process until the absolute value of the difference Td3 is less than ΔT2. In this manner, the difference between the transmission timing of the downlink frame to be transmitted from the end of the antenna 40 of the RE 30 and the reference timing can be adjusted so as to fall within a predetermined value.

Configuration of the RE 30

For example, as illustrated in FIG. 2, the RE 30 includes a reception SERDES 31, a CPRI reception unit 32, a transmission SERDES 33, a CPRI transmission unit 34, a measurement unit 35, a control unit 36, a storage unit 37, and a wireless processing unit 38.

The reception SERDES 31 receives a downlink frame from the REC 20 at the connection point R2 through the cable 12a, and converts the received downlink frame, which is an optical signal, into an electric signal. The reception SERDES 31 then converts the converted downlink frame, which is a serial signal, into a parallel signal, and outputs the resultant signal to the CPRI reception unit 32.

The CPRI reception unit 32 determines whether synchronization of the downlink is established based on the synchronization signal having been added at the beginning of the downlink frame that is output from the reception SERDES 31. For example, the CPRI reception unit 32 determines that the synchronization of the downlink is established when a synchronization signal is successfully detected four consecutive times. The CPRI reception unit 32 then determines whether synchronization of the CPRI link is established, by using data included in the downlink frame having been output from the reception SERDES 31. For example, the CPRI reception unit 32 determines that the synchronization of the CPRI link is established when information such as a protocol version and a bit rate included in the header of the downlink frame is detected as the predetermined information after the synchronization of the downlink has been established.

The CPRI reception unit 32 then outputs the downlink frame having been output from the reception SERDES 31 to the control unit 36 and the wireless processing unit 38 after the synchronization of the CPRI link has been established with the REC 20.

The CPRI reception unit 32 also notifies the control unit 36 of a downlink synchronization loss when the downlink synchronization loss is detected. For example, the CPRI reception unit 32 detects a downlink synchronization loss when a synchronization signal is not detected three consecutive times, while the synchronization of the downlink is being established.

The CPRI transmission unit 34 creates an uplink frame by using a signal output from the wireless processing unit 38. The CPRI transmission unit 34 outputs the created uplink frame to the transmission SERDES 33 at a timing instructed by the control unit 36. The CPRI transmission unit 34 also outputs an uplink frame to the transmission SERDES 33 at a timing instructed by the control unit 36 when the uplink frame is output from the control unit 36.

The transmission SERDES 33 converts the uplink frame having been output from the CPRI transmission unit 34, which is a parallel signal, into a serial signal. The transmission SERDES 33 then converts the converted uplink frame, which is an electric signal, into an optical signal, and transmits the resultant signal to the cable 12b from the connection point R3.

The wireless processing unit 38 removes the synchronization signal from the downlink frame having been output from the CPRI reception unit 32. The wireless processing unit 38 then performs a predetermined process such as up-conversion and amplification on the downlink frame from which the synchronization signal is removed. The wireless processing unit 38 then outputs the downlink frame signal after being processed to the antenna 40 from the connection point Ra at a timing at which T2a has passed from the timing when the reception SERDES 31 has received the downlink frame at the connection point R2. The downlink frame signal output from the connection point Ra is wirelessly transmitted from the antenna 40. The wireless processing unit 38 also performs a predetermined process such as amplification and down-conversion on the signal received through the antenna 40. The wireless processing unit 38 then outputs the processed signal to the CPRI transmission unit 34.

For example, as illustrated in FIG. 4, the storage unit 37 stores therein T2a, Toffset1, and Toffset2. FIG. 4 is a diagram illustrating an example of data stored in the storage unit 37. T2a and Toffset1 are stored in the storage unit 37 in advance by a manufacturer of the RE 30, for example. Toffset2 is stored in the storage unit 37 by being measured by the measurement unit 35, which will be described below.

In the timing adjustment process, the measurement unit 35 measures Toffset2 that is a time from when a downlink frame is received at the connection point R2 to when an uplink frame is transmitted at the connection point R3, when the synchronization of the downlink is established for the second time and thereafter. The measurement unit 35 then stores the measured Toffset2 in the storage unit 37.

In the timing adjustment process, when the first synchronization of the downlink is established, the control unit 36 activates the transmission SERDES 33 and the CPRI transmission unit 34. The control unit 36 then reads out Toffset1 from the storage unit 37. The control unit 36 then outputs an uplink frame corresponding to the downlink frame to the CPRI transmission unit 34 so that the uplink frame is transmitted from the connection point R3 after the time of Toffset1 has passed from when the downlink frame is received at the connection point R2. In this manner, the downlink frame received at the connection point R2 is transmitted from the connection point R3 as an uplink frame at a timing delayed by Toffset1 from the timing when the downlink frame is received at the connection point R2.

In addition to outputting the signal the same as that of the downlink frame to the CPRI transmission unit 34 as an uplink frame, the control unit 36 may also output a signal that corresponds to the downlink frame and that is different from the downlink frame to the CPRI transmission unit 34, as an uplink frame.

In the present embodiment, the control unit 36 adjusts the timing of outputting an uplink frame corresponding to the downlink frame to the CPRI transmission unit 34 so that the uplink frame is transmitted from the connection point R3 after the time of Toffset1 has passed from when the downlink frame is received at the connection point R2. However, the disclosed technology is not limited thereto. For example, the control unit 36 may also output an uplink frame corresponding to the downlink frame having been received at the connection point R2 to the CPRI transmission unit 34, without adjusting the output timing. In this case, a delay time as a result from when a downlink frame is received at the connection point R2 to when an uplink frame corresponding to the downlink frame is transmitted from the connection point R3 will be stored in the storage unit 37 as Toffset1.

In the timing adjustment process, if a downlink frame including an RE device configuration information request is output from the CPRI reception unit 32, after the first synchronization of the downlink has been established, the control unit 36 acquires T2a and Toffset1 from the storage unit 37. The control unit 36 then creates an RE device configuration information response including T2a and Toffset1. The control unit 36 then outputs the downlink frame including the RE device configuration information response, to the CPRI transmission unit 34. In this manner, the RE device configuration information response including T2a and Toffset1 is transmitted to the REC 20 through the cable 12b.

In the timing adjustment process, when a downlink synchronization loss is detected after the first synchronization of the downlink has been established, the control unit 36 causes the transmission SERDES 33 and the CPRI transmission unit 34 to continuously transmit the uplink frame. For example, the control unit 36 causes the transmission SERDES 33 and the CPRI transmission unit 34 to continuously transmit the uplink frame, by continuously outputting the uplink frame to the CPRI transmission unit 34.

In this example, the transmission timing of the uplink frame to be transmitted from the transmission SERDES 33 while the synchronization of the downlink is being lost is the same timing as that of the uplink frame having been transmitted while the synchronization of the downlink is being established. In addition, for example, the uplink frame to be transmitted from the transmission SERDES 33 while the synchronization of the downlink is being lost is a predetermined uplink frame that includes information indicating that the synchronization of the downlink is being lost. Furthermore, for example, the uplink frame to be transmitted from the transmission SERDES 33, while the synchronization of the downlink is being lost, may be the uplink frame that is last transmitted while the synchronization of the downlink is being established. Such an uplink frame may be transmitted repeatedly.

In the timing adjustment process, the control unit 36 reads out Toffset2 from the storage unit 37, when the second synchronization of the downlink is established. The control unit 36 then determines whether the time indicated by Toffset2 is less than a predetermined time ΔT3. For example, the predetermined time ΔT3 is a period corresponding to 256 chips, in a signal having a chip rate of 3.84 MHz. The predetermined time ΔT3 is an example of a third time.

If the time indicated by Toffset2 is equal to or more than the predetermined time ΔT3, the control unit 36 rewrites the value of Toffset2 in the storage unit 37, with the value of Toffset1 in the storage unit 37. The control unit 36 then outputs the uplink frame corresponding to the downlink frame to the CPRI transmission unit 34 after the time of Toffset1 has passed from when the downlink frame is received at the connection point R2. In this manner, the transmission timing of the uplink frame to be transmitted from the connection point R3 is changed to the timing at which the time of Toffset1 has passed from the reception timing of the downlink frame having been received at the connection point R2.

In the timing adjustment process, if the downlink frame including the RE device configuration information request is output from the CPRI reception unit 32 after the synchronization of the downlink is established for the second time, the control unit 36 acquires Toffset2 from the storage unit 37. The control unit 36 then creates an RE device configuration information response including Toffset2. The control unit 36 then outputs the downlink frame including the RE device configuration information response to the CPRI transmission unit 34. In this manner, the RE device configuration information response including Toffset2 is transmitted to the REC 20 through the cable 12b.

When the downlink frame including a message indicating that the timing adjustment process has finished is output from the CPRI reception unit 32, the control unit 36 completes the timing adjustment process.

Operation of the Transmission System 10

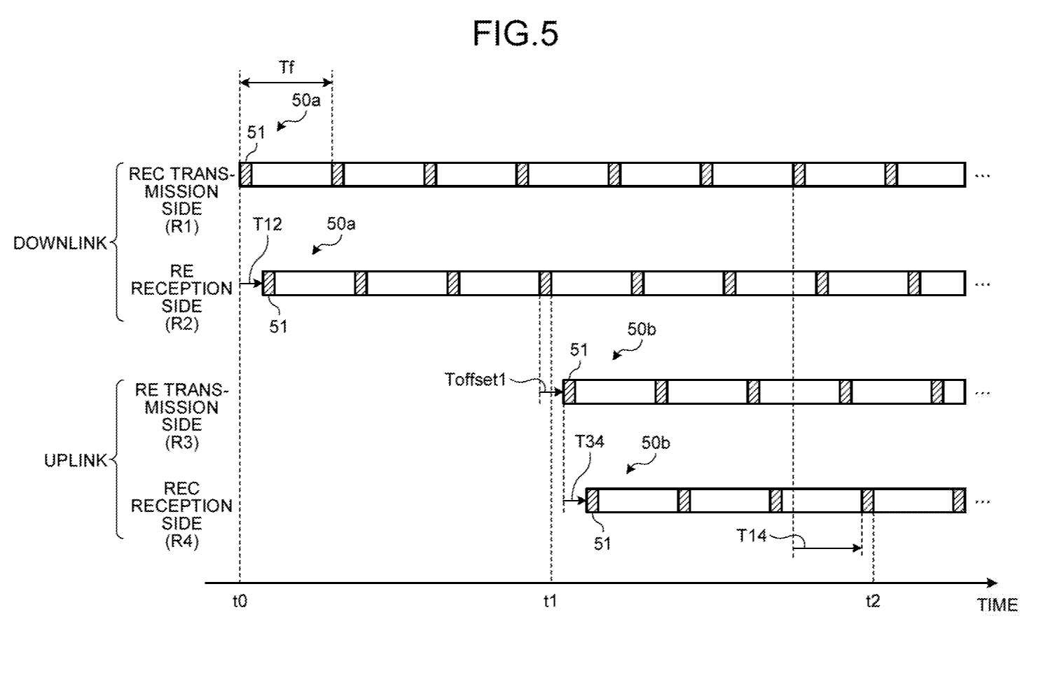

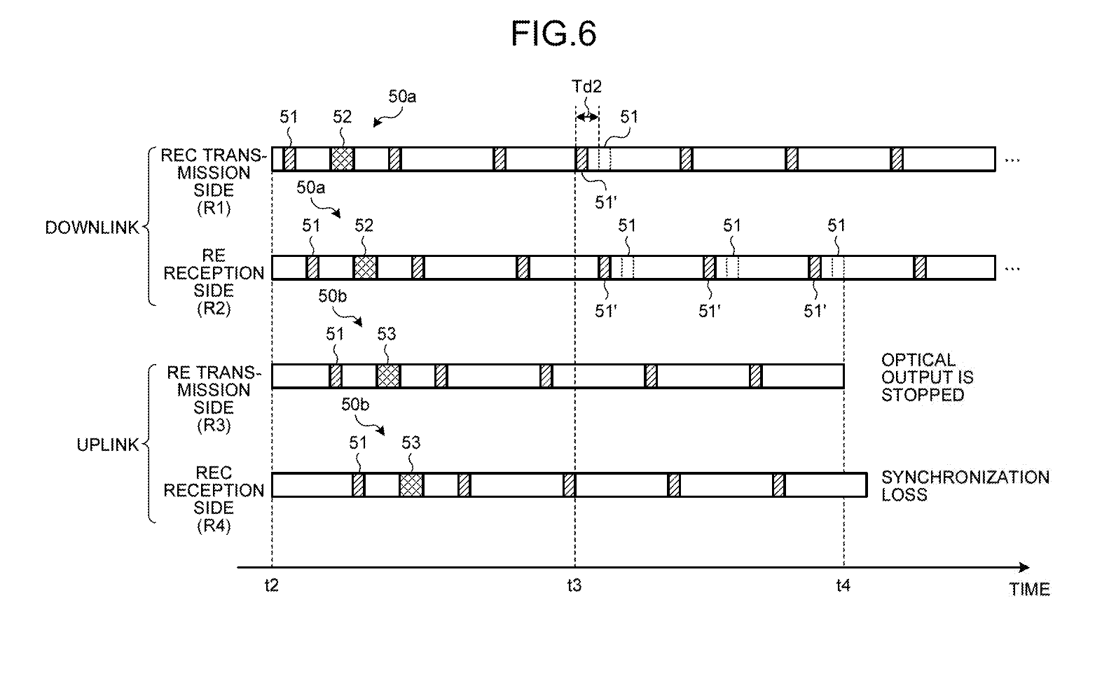

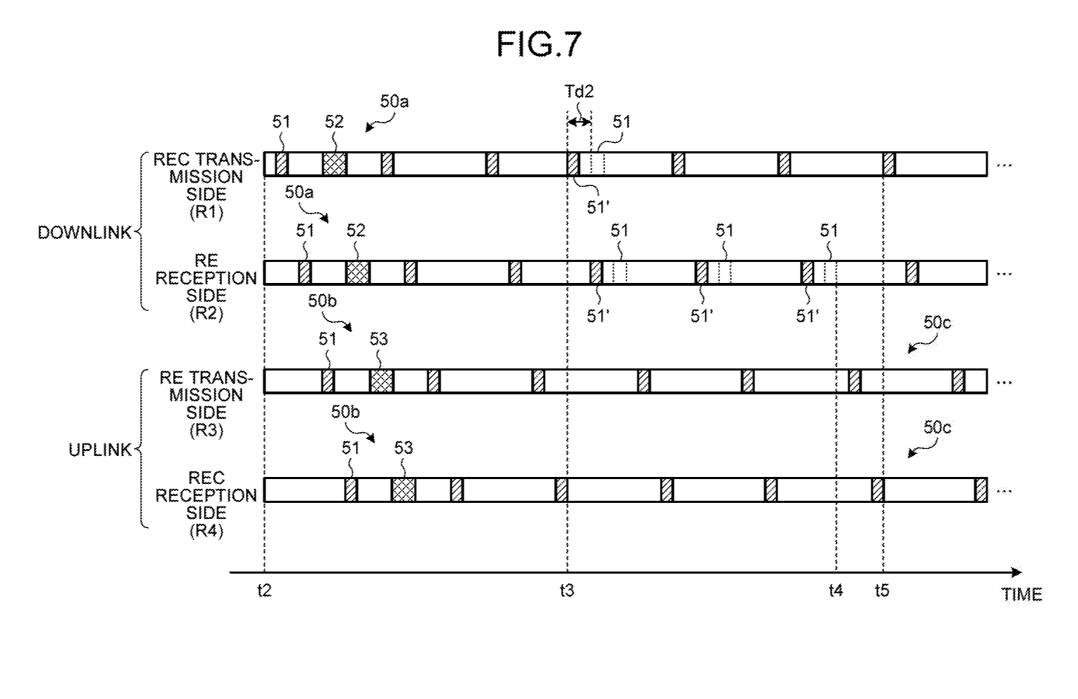

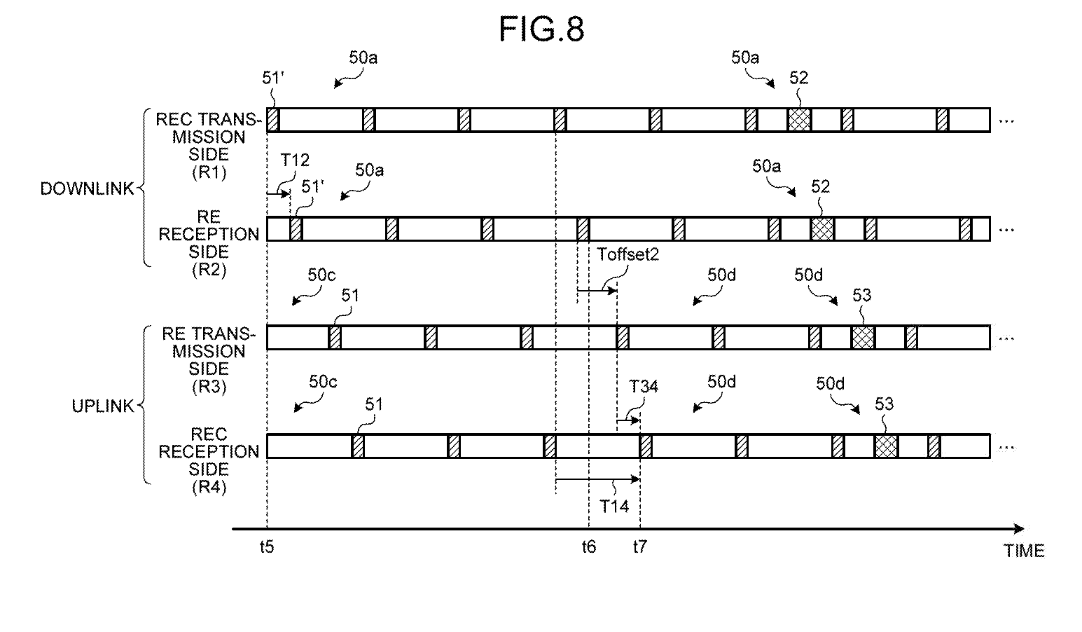

FIG. 5 to FIG. 8 are diagrams illustrating examples of operations of the transmission system 10. FIG. 5 is a diagram illustrating an example of an operation of the transmission system 10 when the first synchronization is established. FIG. 6 is a diagram illustrating an example of an operation of a conventional transmission system when the timing of the downlink frame is changed. FIG. 7 and FIG. 8 are diagrams illustrating examples of operations of the transmission system 10 of the present embodiment when the timing of the downlink frame is changed.

For example, as illustrated in FIG. 5, the REC 20 starts transmitting the downlink frame 50a from the connection point R1 every period of Tf (in the present embodiment, such as 66 microseconds) of one frame, at a time t0. The downlink frame 50a having been transmitted from the REC 20 is received at the connection point R2 of the RE 30 through the cable 12a after T12. For example, the RE 30 detects the synchronization of the downlink, when the synchronization signal 51 having been added at the beginning of the downlink frame 50a is successfully received four consecutive times, at a time t1.

If the synchronization of the downlink is detected, the RE 30 starts transmitting the uplink frame 50b corresponding to the downlink frame 50a from the connection point R3. The uplink frame 50b is transmitted from the connection point R3 after the time of Toffset1 has passed from when the downlink frame 50a is received at the connection point R2.

The uplink frame 50b that is transmitted from the RE 30 is received at the connection point R4 of the REC 20 through the cable 12b after T34. For example, the REC 20 detects the synchronization of the uplink, when the synchronization signal 51 having been added at the beginning of the uplink frame 50b is successfully received four consecutive times, at a time t2.

The REC 20 then measures the round-trip time T14 that is from when the downlink frame 50a is transmitted at the connection point R1 to when the uplink frame 50b corresponding to the downlink frame 50a is received at the connection point R4.

As illustrated in FIG. 5, at least three periods of Tf of the downlink frame 50a are included between the time t0 and the time t1. In addition, at least three periods of Tf of the uplink frame 50b are included between the time t1 and the time t2. Thus, at least a period of 6×Tf is needed before the synchronization of the downlink and the uplink is established between the REC 20 and the RE 30.

An operation of a conventional transmission system after the synchronization of the downlink frame 50a and the uplink frame 50b has been established will now be described with reference to FIG. 6. For example, as illustrated in FIG. 6, when the synchronization of the uplink has been established at the time t2, the REC 20 transmits the downlink frame 50a including an RE device configuration information request 52, from the connection point R1. The RE 30 then receives the downlink frame 50a including the RE device configuration information request 52 at the connection point R2 after T12 has passed.

The RE 30 then creates an RE device configuration information response 53 including information such as Toffset1 and T2a. The RE 30 then transmits the uplink frame 50b including the created RE device configuration information response 53 from the connection point R3. The REC 20 receives the uplink frame 50b including the RE device configuration information response 53 at the connection point R4.

Next, the REC 20 calculates the time difference Td2 that is a time difference between the reference timing Tr and a timing at which Td1 has passed from the transmission timing Tc of the current downlink frame at the connection point R1, by using formulae (1) to (3) described above, for example. In the example of FIG. 6, it is assumed that the absolute value of Td2 is equal to or more than the predetermined threshold ΔT1. Because the absolute value of Td2 is equal to or more than the predetermined threshold ΔT1, the REC 20 changes the transmission timing Tc of the current downlink frame at the connection point R1 to a timing shifted by Td2, at a time t3, for example. In this manner, as illustrated in FIG. 6, a timing of a synchronization signal 51′ is changed to a timing shifted by Td2 from the timing of the synchronization signal 51, for example.

In the RE 30, the synchronization signal 51 is detected at the timing before the transmission timing of the downlink frame 50a is changed. Thus, the synchronization signal 51 will not be detected. At a time t4, when the synchronization signal 51 is not detected three consecutive times, the RE 30 detects a downlink synchronization loss. When the downlink synchronization loss is detected, the conventional RE 30 stops transmitting the uplink frame 50b, by stopping the transmission SERDES 33. Thus, the optical output of the uplink is stopped at the connection point R3. In this manner, the uplink frame 50b will not be received at the connection point R4, and the REC 20 detects the synchronization loss.

The conventional transmission system then starts an operation for establishing synchronization illustrated in FIG. 5 again after the time t4. When the synchronization between the REC 20 and the RE 30 is established again, the REC 20 measures T14 again, and calculates Td2 by using the re-measured T14, Toffset1 that is acquired after the first synchronization has been established, and formulae (1) to (3) described above. The REC 20 then determines whether the absolute value of Td2 is less than the predetermined threshold ΔT1. If the absolute value of Td2 is equal to or more than the predetermined threshold ΔT1, the REC 20 executes the operation illustrated in FIG. 6, and the operation illustrated in FIG. 5 again.

As illustrated in FIG. 6, at least three periods of Tf of the downlink frame 50a are included between the time t2 and the time t4. Thus, at least a time of 3×Tf is needed before the timing of the downlink frame is changed and the synchronization loss is detected.

In this example, when a downlink synchronization loss is detected, the RE of the conventional transmission system stops transmitting the uplink frame 50b, by stopping the transmission SERDES that transmits the uplink frame 50b. Then, when the synchronization of the downlink is reestablished, the RE starts transmitting the uplink frame 50b again, by activating the transmission SERDES. In this process, if the transmission SERDES is activated after being stopped temporarily, a delay error that is included in the signal having been output from the transmission SERDES before being stopped and a delay error that is included in the signal output from the transmission SERDES after being reactivated may differ.

Consequently, when T14 is measured again after the REC 20 has changed the timing of the downlink frame 50a, the delay error of the transmission SERDES that is included in T14 may change. Thus, even if the actual absolute value of Td2 is less than the predetermined threshold ΔT1, the absolute value of Td2 having been calculated based on the re-measured T14 may be determined to be equal to or more than the predetermined threshold ΔT1 due to the change in the delay error of the transmission SERDES. If the absolute value of Td2 is equal to or more than the predetermined threshold ΔT1, the REC 20 and the RE 30 will execute the operation illustrated in FIG. 6, and the operation illustrated in FIG. 5 again. Furthermore, even if the operation illustrated in FIG. 6 and the operation illustrated in FIG. 5 are performed, because the delay error of the transmission SERDES changes each time, not every absolute value of Td2 having been calculated based on T14 being subsequently measured is less than the predetermined threshold ΔT1. Hence, in the conventional transmission system, the operation illustrated in FIG. 6 and the operation illustrated in FIG. 5 are repeated, until the absolute value of Td2 is less than the predetermined threshold ΔT1. Thus, the timing adjustment process takes a long time to finish.

In addition, for example, as the RE 30-4 illustrated in FIG. 1, in the RE 30 that is cascade connected via another RE 30, the number of the transmission SERDES in the uplink between the RE 30 and the REC 20 will be increased. Consequently, the probability of the absolute value of Td2 becoming less than the predetermined threshold ΔT1 is further reduced, because of the accumulation of the delay error of each transmission SERDES. Thus, the timing adjustment process takes longer time to finish.

However, in the timing adjustment process, the transmission system 10 of the present embodiment operates as illustrated in FIG. 7 and FIG. 8, for example, after the first synchronization has been established as illustrated in FIG. 5. In other words, as illustrated in FIG. 7, for example, when the first synchronization of the uplink is established at the time t2, the REC 20 transmits the downlink frame 50a including the RE device configuration information request 52 from the connection point R1. After T12 has passed, the RE 30 receives the downlink frame 50a including the RE device configuration information request 52, at the connection point R2.

The RE 30 then transmits the uplink frame 50b including the RE device configuration information response 53 including information such as Toffset1 and T2a, from the connection point R3. After T34 has passed, the REC 20 receives the uplink frame 50b including the RE device configuration information response 53 at the connection point R4.

Next, the REC 20 calculates the time difference Td2 that is a time difference between the reference timing Tr and a timing at which Td1 has passed from the transmission timing Tc of the current downlink frame at the connection point R1, by using formulae (1) to (3) described above, for example. In the example of FIG. 7, it is assumed that the absolute value of Td2 is equal to or more than the predetermined threshold ΔT1. Because the absolute value of Td2 is equal to or more than the predetermined threshold ΔT1, the REC 20 changes the transmission timing Tc of the current downlink frame at the connection time R1 to the timing shifted by Td2, at the time t3, for example. In this manner, as illustrated in FIG. 7, for example, the timing of the synchronization signal 51′ is changed to a timing shifted by Td2 from the timing of the synchronization signal 51. If the transmission timing of the downlink frame 50a is changed, the REC 20 estimates Toffset2e that is an expected value of Toffset2, by using formula (4) described above.

Because the transmission timing of the downlink frame is changed, the synchronization signal 51 will not be detected in the RE 30, at the timing of the synchronization signal 51 before the transmission timing of the downlink frame 50a is changed. Then, at the time t4 when the synchronization signal 51 is not detected three consecutive times, the RE 30 detects a downlink synchronization loss. When the downlink synchronization loss is detected, the RE 30 of the present embodiment continuously transmits an uplink frame 50c, without stopping the transmission SERDES 33. For example, the uplink frame 50c is a hyperframe including information indicating that the synchronization of the downlink is being lost and the like. The synchronization signal 51 is added at the beginning of the uplink frame 50c. In this manner, the REC 20 can maintain synchronization of the uplink.

For example, as illustrated in FIG. 8, the RE 30 establishes the synchronization of the downlink again based on the synchronization signal of the downlink frame 50a having been received at the connection point R2, from a time t5 that is after the downlink synchronization loss is detected. The RE 30 then detects the second synchronization of the downlink at a time t6, when the synchronization signal 51′ having been added at the beginning of the downlink frame 50a is successfully received four consecutive times, for example.

After the second synchronization is detected, the RE 30 transmits the received downlink frame 50a as an uplink frame 50d. The RE 30 then measures the time difference Toffset2 that is a time difference between the reception timing of the downlink frame 50a at the connection point R2 and the transmission timing of the uplink frame 50d at the connection point R3. The RE 30 then stores the measured Toffset2 in the storage unit 37. If the time indicated by Toffset2 is less than a predetermined time, the RE 30 does not change the transmission timing of the uplink frame 50d.

The uplink frame 50d that is transmitted from the connection point R3 through the cable 12b is received at the connection point R4 of the REC 20 after T34 has passed. The REC 20 measures T14 again based on the uplink frame 50d receive at a time t7. The REC 20 then transmits the downlink frame 50a including the RE device configuration information request 52, from the connection point R1. The RE 30 receives the downlink frame 50a including the RE device configuration information request 52 at the connection point R2 after T12 has passed. The RE 30 then creates the RE device configuration information response 53 including information such as Toffset2, and transmits the uplink frame 50d including the RE device configuration information response 53, from the connection point R3.

The REC 20 receives the uplink frame 50d including the RE device configuration information response 53 at the connection point R4, and acquires Toffset2 from the RE device configuration information response 53. The REC 20 then determines whether the absolute value of the difference Td3 that is a difference between the expected value Toffset2e having been estimated by using formula (4) described above and Toffset2 acquired from the RE device configuration information response 53 is less than the predetermined threshold ΔT2. If the absolute value of Td3 is less than the predetermined threshold ΔT2, the REC 20 transmits the downlink frame 50a including a message indicating that the timing adjustment process has finished to the RE 30. By contrast, if the absolute value of Td3 is equal to or more than the predetermined threshold ΔT2, the processes subsequent to the time t3 illustrated in FIG. 7 will be performed again.

In the present embodiment, the RE 30 continuously transmits the uplink frame 50c without stopping the transmission SERDES 33, even if the downlink synchronization loss is detected. Thus, the delay error variation caused by reactivating the transmission SERDES 33 will not occur. In addition, the delay in the RE 30 is kept constant, in measuring T14. Consequently, the probability of the absolute value of Td2, which is obtained based on T14 having been re-measured after the REC 20 has changed the timing of the downlink frame 50a, being less than the predetermined threshold ΔT1 will be increased. As a result, the transmission system 10 of the present embodiment can prevent useless readjustment caused by the delay error variation of the transmission SERDES 33. Hence, the transmission system 10 of the present embodiment can reduce the time to complete the timing adjustment process than that of the conventional transmission system.

In the conventional transmission system, the transmission of the uplink frame 50b is stopped due to the downlink synchronization loss when the transmission timing of the downlink frame 50a is changed. Consequently, the synchronization of the uplink is being lost in the REC 20. Thus, in the conventional transmission system, if the synchronization of the downlink is lost due to the change in the transmission timing of the downlink frame 50a, the uplink resynchronization is performed, in addition to the downlink resynchronization. The resynchronization of the uplink includes at least three periods of Tf of the uplink frame 50b.

However, in the transmission system 10 of the present embodiment, even if the synchronization of the downlink is lost due to the change in the transmission timing of the downlink frame 50a, the uplink frame 50c is continuously transmitted. Thus, even if the synchronization of the downlink is being lost in the RE 30, the synchronization of the uplink is maintained in the REC 20. Consequently, in the transmission system 10 of the present embodiment, if the synchronization of the downlink is being lost due to the change in the transmission timing of the downlink frame 50a, the resynchronization of the uplink is not performed, as long as the downlink is resynchronized. Thus, the transmission system 10 of the present embodiment can reduce the time to complete the timing adjustment process than that of the conventional transmission system.

Operation of the REC 20

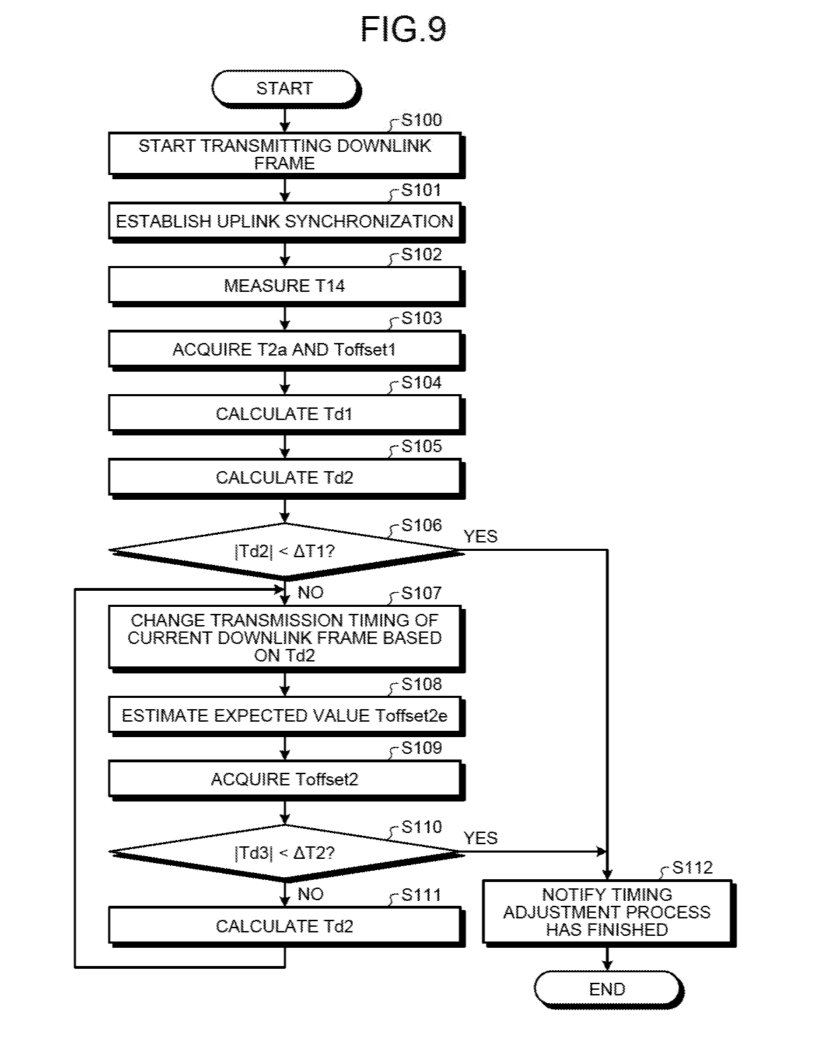

FIG. 9 is a flowchart illustrating an example of the timing adjustment process in the REC 20. The REC 20 starts the timing adjustment process illustrated in FIG. 9, at a predetermined timing such as when an instruction is received from a manager and the like. The timing adjustment process illustrated in FIG. 9 is an example of the synchronization establishment method to be performed by the REC 20.

The adjustment unit 25 starts transmitting the downlink frame via the CPRI transmission unit 21 (S100). The CPRI reception unit 23 then determines whether the synchronization of the uplink is established based on the synchronization signal having been added to the uplink frame from the RE 30 (S101). If the CPRI reception unit 23 determines that the synchronization of the uplink is established, the adjustment unit 25 measures the round-trip time T14, based on the downlink frame transmitted to the RE 30 and the uplink frame received from the RE 30 (S102).

Next, the adjustment unit 25 transmits the downlink frame including the RE device configuration information request to the RE 30 via the CPRI transmission unit 21. The adjustment unit 25 receives the RE device configuration information response from the RE 30, and acquires Toffset1 and T2a from the received RE device configuration information response (S103).

Next, the adjustment unit 25 calculates Td1, by using T14 measured at step S102, Toffset1 acquired from the RE device configuration information response, and formulae (1) and (2) described above (S104). The adjustment unit 25 then calculates Td2, by using the calculated Td1 and formula (3) described above (S105).

Next, the adjustment unit 25 determines whether the absolute value of Td2 is less than the threshold ΔT1 (S106). If the absolute value of Td2 is less than the threshold ΔT1 (Yes at S106), the adjustment unit 25 transmits the downlink frame including a message indicating that the timing adjustment process has finished to the RE 30 via the CPRI transmission unit 21 (S112). The REC 20 then completes the timing adjustment process illustrated in the present flowchart.

If the absolute value of Td2 is equal to or more than the threshold ΔT1 (No at S106), the adjustment unit 25 changes the transmission timing Tc of the current downlink frame at the connection point R1, based on Td2 (S107). The adjustment unit 25 then estimates Toffset2e that is an expected value of Toffset having changed due to the change in the transmission timing of the downlink frame, by using Td2 and formula (4) described above (S108).

Next, the adjustment unit 25 transmits the downlink frame including the RE device configuration information request to the RE 30 via the CPRI transmission unit 21. The adjustment unit 25 then receives the RE device configuration information response from the RE 30, and acquires Toffset2 that is Toffset having changed due to the change in the transmission timing of the downlink frame, from the received RE device configuration information response (S109).

Next, the adjustment unit 25 determines whether the absolute value of the difference Td3 that is a difference between the expected value Toffset2e estimated at step S108 and Toffset2 acquired from the RE 30 is less than the predetermined threshold ΔT2 (S110). If the absolute value of Td3 is less than ΔT2 (Yes at S110), the adjustment unit 25 performs the process at step S112.

If the absolute value of Td3 is equal to or more than ΔT2 (No at S110), the adjustment unit 25 measures T14 again. The adjustment unit 25 then calculates T12 again, by using formula (1) described above, in which Toffset2 replaces Toffset1. The adjustment unit 25 further calculates Td1 again, by using the recalculated T12 and formula (2) described above. The adjustment unit 25 further calculates Td2 again, by using the recalculated Td1 and formula (3) described above (S111). The adjustment unit 25 then performs the process at step S107 again.

Operation of the RE 30

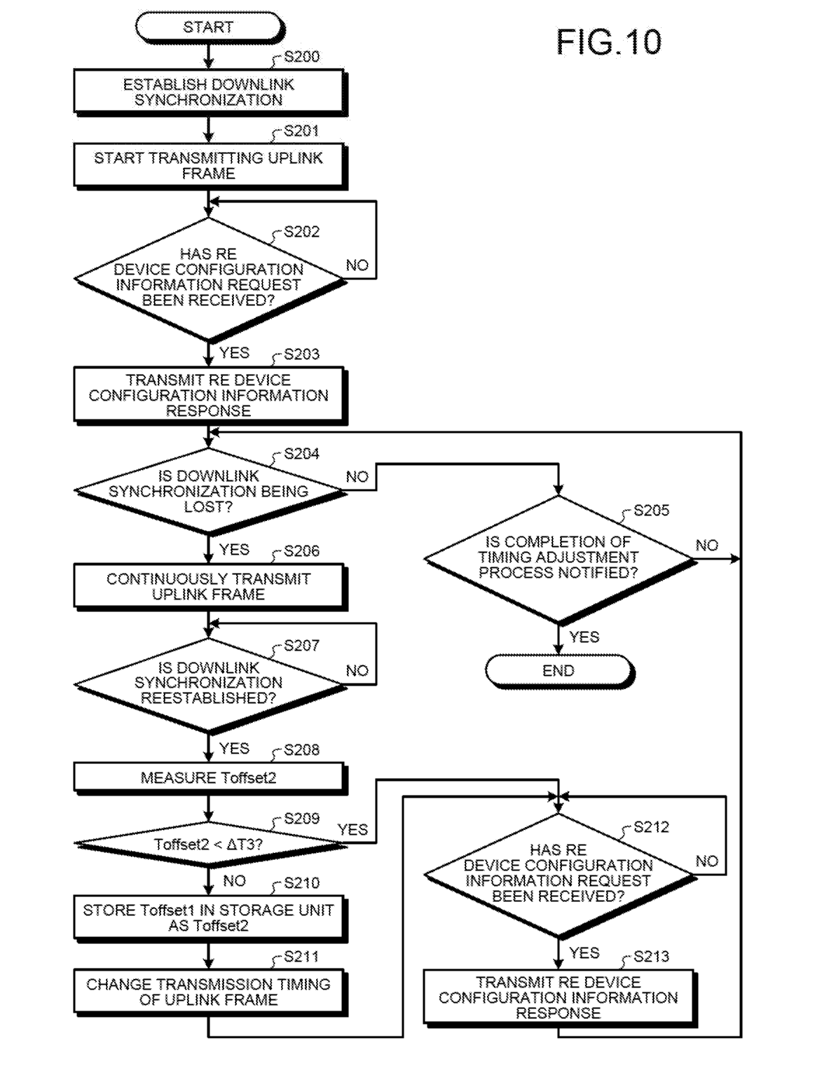

FIG. 10 is a flowchart illustrating an example of the timing adjustment process in the RE 30. For example, the RE 30 starts the timing adjustment process illustrated in FIG. 10, at a predetermined timing such as when reset is released. The timing adjustment process illustrated in FIG. 10 is an example of the synchronization establishment method to be performed by the RE 30.

First, the CPRI reception unit 32 determines whether synchronization of the downlink is established based on the synchronization signal having been added to the downlink frame from the REC 20 (S200). When the CPRI reception unit 32 determines that the synchronization of the downlink is established, the control unit 36 activates the transmission SERDES 33 and the CPRI transmission unit 34. The control unit 36 then reads out Toffset1 from the storage unit 37. The control unit 36 further outputs an uplink frame corresponding to a downlink frame to the CPRI transmission unit 34 after Toffset1 has passed from when the downlink frame is received at the connection point R2. In this manner, the downlink frame having been received at the connection point R2 starts to be transmitted from the connection point R3 as an uplink frame after the time of Toffset1 has passed (S201).

Next, the control unit 36 determines whether the RE device configuration information request has been received, by referring to the payload of the downlink frame having been output from the CPRI reception unit 32 (S202). If the RE device configuration information request has not been received (No at S202), the control unit 36 performs the process at step S202 again.

By contrast, if the RE device configuration information request has been received (Yes at S202), the control unit 36 acquires T2a and Toffset1 from the storage unit 37. The control unit 36 then creates the RE device configuration information response including T2a and Toffset1. The control unit 36 then outputs the downlink frame including the RE device configuration information response to the CPRI transmission unit 34. In this manner, the RE device configuration information response including T2a and Toffset1 is transmitted to the REC 20 through the cable 12b (S203).

Next, the control unit 36 determines whether the CPRI reception unit 32 has detected a downlink synchronization loss (S204). If the downlink synchronization loss is not detected (No at S204), the control unit 36 determines whether the completion of the timing adjustment process is notified, by referring to the payload of the downlink frame having been output from the CPRI reception unit 32 (S205). If the completion of the timing adjustment process is not notified (No at S205), the control unit 36 performs the process at S204 again. If the completion of the timing adjustment process is notified (Yes at S205), the RE 30 completes the timing adjustment process illustrated in the present flowchart.

If the downlink synchronization loss is detected (Yes at S204), the control unit 36 causes the transmission SERDES 33 and the CPRI transmission unit 34 to continuously transmit the uplink frame, by continuously outputting the uplink frame to the CPRI transmission unit 34 (S206). The measurement unit 35 then determines whether synchronization of the downlink is reestablished, by referring to the output from the CPRI reception unit 32 (S207). If the synchronization of the downlink is not established (No at S207), the measurement unit 35 performs the process at step S207 again.

If the synchronization of the downlink is reestablished (Yes at S207), the measurement unit 35 measures Toffset2 that is a time from when a downlink frame is received at the connection point R2 to when the downlink frame is transmitted from the connection point R3 as an uplink frame (S208). The measurement unit 35 then stores the measured Toffset2 in the storage unit 37.

Next, the control unit 36 determines whether the time indicated by Toffset2 having been stored in the storage unit 37 is less than the predetermined time ΔT3 (S209). If the time indicated by Toffset2 is less than ΔT3 (Yes at S209), the control unit 36 performs the process at step S212, without changing the transmission timing of the uplink frame.

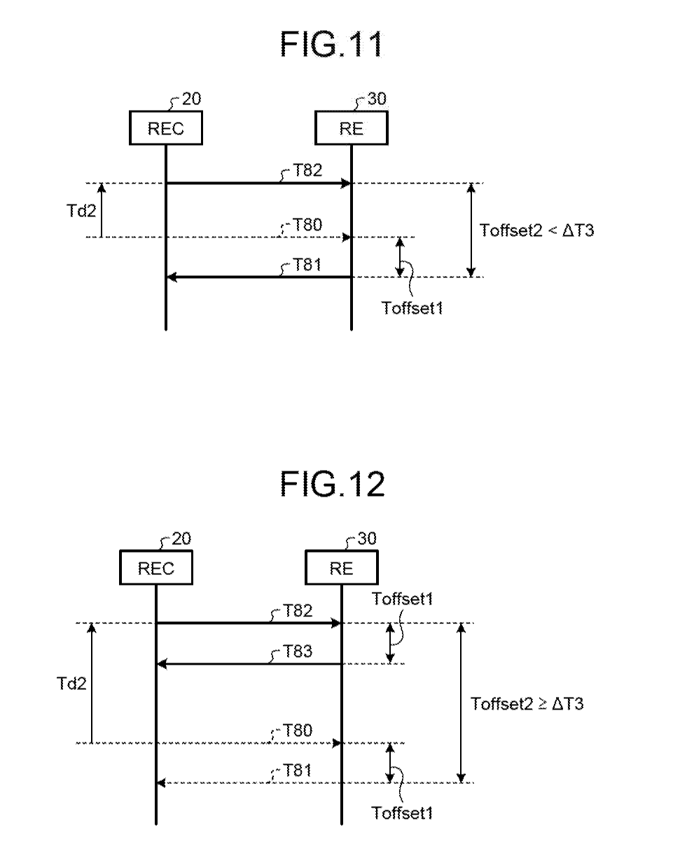

FIG. 11 is a diagram for explaining a transmission timing of the uplink frame. For example, as illustrated in FIG. 11, even if the downlink synchronization loss is detected, the RE 30 transmits an uplink frame at a timing T81 at which Toffset1 has passed from a reception timing T80 of the downlink frame, before the transmission timing is changed. If the reception timing of the downlink frame is changed from T80 to T82, due to the change in the transmission timing of the downlink frame, the time from when the RE 30 receives a downlink frame to when the RE 30 transmits the downlink frame as an uplink frame is Toffset2. In the example of FIG. 11, because the time indicated by Toffset2 is less than ΔT3, the RE 30 will not change the transmission timing T81 of the uplink frame. In this manner, the RE 30 transmits the uplink frame at the timing T81 at which Toffset2 has passed from the reception timing T82 of the downlink frame after the transmission timing of the downlink frame has changed.

The description will continue by returning to FIG. 10. If the time indicated by Toffset2 is equal to or more than ΔT3 (No at S209), the control unit 36 rewrites the value of Toffset2 in the storage unit 37 with the value of Toffset1 in the storage unit 37. Thus, the value of Toffset1 is stored in the storage unit 37, as the value of Toffset2 (S210). The control unit 36 then changes the transmission timing of the uplink frame so that the uplink frame corresponding to the downlink frame is transmitted from the connection point R3 after Toffset1 has passed from when the downlink frame is received at the connection point R2 (S211).

FIG. 12 is a diagram for explaining a transmission timing of the uplink frame. For example, as illustrated in FIG. 12, even if the downlink synchronization loss is detected, the RE 30 transmits an uplink frame at the timing T81 at which Toffset1 has passed from the reception timing T80 of the downlink frame, before the transmission timing has changed. If the reception timing of the downlink frame is changed from T80 to T82, due to the change in the transmission timing of the downlink frame, the time from when the RE 30 receives a downlink frame to when the RE 30 transmits an uplink frame is Toffset2. In the example of FIG. 12, because the time indicated by Toffset2 is equal to or more than ΔT3, the RE 30 changes the transmission timing of the uplink frame from T81 to T83. In this manner, the RE 30 transmits the uplink frame at the timing T83 at which Toffset1 has passed from the reception timing T82 of the downlink frame after the transmission timing of the downlink frame has changed.

When the RE 30 changes the transmission timing of the uplink frame, the synchronization of the uplink frame is lost in the REC 20 and then the resynchronization is established. The REC 20 acquires Toffset2 from the RE 30. The REC 20 also calculate the difference Td3 that is a difference between Toffset2e having been estimated after the transmission timing of the downlink frame is changed and Toffset2 acquired from the RE 30. If the RE 30 changes the transmission timing of the uplink frame, in many cases, the absolute value of the difference Td3 becomes equal to or more than the predetermined threshold ΔT2. Thus, the REC 20 calculates Td2 again, and changes the transmission timing of the downlink frame again based on the calculated Td2.

The description will continue by returning to FIG. 10. The control unit 36 determines whether the RE device configuration information request has been received, by referring to the payload of the downlink frame having been output from the CPRI reception unit 32 (S212). If the RE device configuration information request has not been received (No at S212), the control unit 36 performs the process at step S212 again.

If the RE device configuration information request has been received (Yes at S212), the control unit 36 acquires Toffset2 from the storage unit 37. The control unit 36 then creates the RE device configuration information response including Toffset2. The control unit 36 then outputs the downlink frame including the RE device configuration information response to the CPRI transmission unit 34. In this manner, the RE device configuration information response including Toffset2 is transmitted to the REC 20 through the cable 12b (S213). The control unit 36 then performs the process at step S204 again.

Hardware

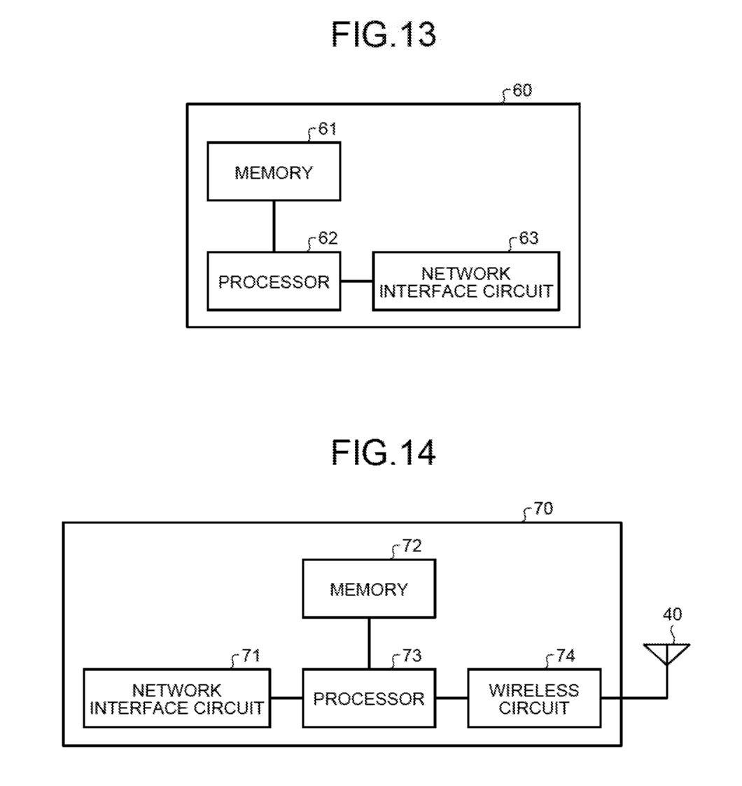

FIG. 13 is a diagram illustrating an example of hardware of a communication device 60 that implements the REC 20. For example, as illustrated in FIG. 13, the communication device 60 includes a memory 61, a processor 62, and a network interface circuit 63.

For example, the processor 62 implements the functions of the CPRI transmission unit 21, the CPRI reception unit 23, and the adjustment unit 25. For example, the network interface circuit 63 implements the functions of the transmission SERDES 22 and the reception SERDES 24. Various computer programs such as computer programs for implementing the functions of the CPRI transmission unit 21, the CPRI reception unit 23, and the adjustment unit 25 are stored in the memory 61. The processor 62 executes the computer program read out from the memory 61, and implements the function of the REC 20 in cooperation with the network interface circuit 63 and the like.

FIG. 14 is a diagram illustrating an example of hardware of a communication device 70 that implements the RE 30. For example, as illustrated in FIG. 14, the communication device 70 includes a network interface circuit 71, a memory 72, a processor 73, a wireless circuit 74, and the antenna 40.

The wireless circuit 74 performs a predetermined process such as modulation on a signal output from the processor 73, and transmits the processed signal through the antenna 40. The wireless circuit 74 also performs a predetermined process such as demodulation on the signal received through the antenna 40, and outputs the signal to the processor 73. For example, the wireless circuit 74 implements the function of the wireless processing unit 38.

For example, the network interface circuit 71 implements the functions of the reception SERDES 31 and the transmission SERDES 33. For example, the processor 73 implements the functions of the CPRI reception unit 32, the CPRI transmission unit 34, the measurement unit 35, and the control unit 36. The memory 72 stores therein data in the storage unit 37. The memory 72 also stores therein various computer programs such as computer programs for implementing the functions of the CPRI reception unit 32, the CPRI transmission unit 34, the measurement unit 35, and the control unit 36. The processor 73 executes the computer program read out from the memory 72, and implements the function of the RE 30 in cooperation with the network interface circuit 71, the wireless circuit 74, and the like.

Advantageous Effects of the Embodiment

As is obvious from the above description, after the synchronization of the downlink and the uplink has been established with the RE 30, the REC 20 of the present embodiment adjusts the transmission timing of the downlink frame to be transmitted from the REC 20 so that the transmission timing of the downlink frame from the antenna 40 of the RE 30 becomes a predetermined timing. In addition, when the synchronization of the downlink is established with the REC 20, the RE 30 of the present embodiment starts transmitting the uplink frame. Even if a downlink synchronization loss is detected because the REC 20 has changed the transmission timing of the downlink frame, the RE 30 maintains the transmission timing of the uplink frame. In this manner, it is possible to prevent the delay error variation caused by reactivating the transmission SERDES 33. Thus, the transmission system 10 of the present embodiment can reduce the time to complete the timing adjustment process than that of the conventional transmission system.

When a downlink synchronization loss is detected, the RE 30 of the present embodiment continuously transmits the uplink frame, at the same timing as the transmission timing of the uplink frame that has been transmitted until the downlink synchronization loss is detected. In this manner, even if the synchronization of the downlink is lost, the synchronization of the uplink is maintained in the REC 20. Thus, in the transmission system 10 of the present embodiment, even if the synchronization of the downlink is lost due to the change in the transmission timing of the downlink frame, there is no need to resynchronize the uplink, as long as the downlink is resynchronized. Thus, the transmission system 10 of the present embodiment can reduce the time to complete the timing adjustment process than that of the conventional transmission system.

When the synchronization of the downlink has been reestablished after the downlink synchronization loss is detected, the RE 30 of the present embodiment measures the second time that is a time difference between the timing at which the downlink frame is received after the synchronization of the downlink has been reestablished, and the transmission timing of the uplink frame that has been continuously transmitted. In addition, the REC 20 of the present embodiment estimates the second time that is measured in the RE 30 after the transmission timing of the downlink frame has been changed. If a difference between the estimated second time and the second time measured in the RE 30 is less than a predetermined threshold, the REC 20 determines that the adjustment of the transmission timing of the downlink frame has completed. If the difference between the estimated second time and the second time measured in the RE 30 is equal to or more than the threshold, the REC 20 changes the transmission timing of the downlink frame again based on the second time measured in the RE 30. In this manner, the transmission system 10 of the present embodiment can adjust the transmission timing of the downlink frame so that the timing at which the downlink frame is transmitted from the antenna 40 of the RE 30 becomes a predetermined timing.

When the second time that is measured after the transmission timing of the downlink frame has been changed is longer than the third time, the RE 30 of the present embodiment changes the transmission timing of the uplink frame to a timing at which the first time has passed from when the downlink frame is received. In this manner, the RE 30 can suppress the time from when the downlink frame is received to when the transmission of the uplink frame is started, to fall within the predetermined time.

In the present embodiment, in the timing adjustment based on the signal round-trip time with the REC 20, the RE 30 continuously transmits the uplink frame even if a synchronization loss of the downlink frame is detected. The RE 30 also maintains the transmission timing of the uplink frame. Thus, the transmission system 10 of the present embodiment can prevent useless readjustment of the timing adjustment, and reduce the time for adjusting the timing between the REC 20, which is an example of the wireless control device, and the RE 30, which is an example of the wireless device.

Others

The disclosed technology is not limited to the embodiment described above, and various modifications are possible within the scope of the technology.

For example, in the embodiment described above, in the timing adjustment process, the control unit 36 of the RE 30 continuously transmits the uplink frame, even if a downlink synchronization loss is detected because the REC 20 has changed the transmission timing of the downlink frame. However, the disclosed technology is not limited thereto. For example, in the timing adjustment process, the control unit 36 may stop transmitting the uplink frame, if the resynchronization of the downlink is not established after a predetermined time has passed from when the downlink synchronization loss is detected. Thus, if the synchronization of the downlink is not established due to a break in the cable 12 and the like, it is possible to prevent useless transmission of the uplink frame. The predetermined time is an example of a fourth time.

In the embodiment described above, the adjustment unit 25 of the REC 20 estimates the expected value Toffset2e after the transmission timing of the downlink frame has been changed. The adjustment unit 25 then determines whether the adjustment of the transmission timing of the downlink frame has completed, by determining whether the absolute value of the difference between the estimated expected value Toffset2e and Toffset2 measured in the RE 30 is less than the predetermined threshold ΔT2. However, the disclosed technology is not limited thereto. For example, the adjustment unit 25 measures T14 again after the transmission timing of the downlink frame has been changed, and calculates Td2 by using the re-measured T14, Toffset2 acquired from the RE 30, and formulae (1) to (3) described above. The adjustment unit 25 may then determine that the adjustment of the transmission timing of the downlink frame has completed, if the absolute value of Td2 is less than the predetermined threshold ΔT1.

More specifically, in the operation of the REC 20 illustrated in FIG. 9, the adjustment unit 25 executes the process at step S102 after executing the process at step S107. The adjustment unit 25 then acquires Toffset2 at step S103. At step S103, the adjustment unit 25 calculates T12 again, by using formula (1) described above in which Toffset2 replaces Toffset1, and also calculates Td1 again by using the recalculated T12 and formula (2) described above. At step S105, the adjustment unit 25 calculates Td2 again, by using Td1 and formula (3) described above. Consequently, the adjustment unit 25 executes the process at step S106.

The timing adjustment process in the embodiment described above may be executed at each predetermined timing, while the REC 20 and the RE 30 are being operated. Consequently, it is possible to adjust the transmission timing of the downlink frame at the connection point Ra of each RE 30, by following the changes in the characteristics of the cable 12 and the RE 30 over time. However, if the REC 20 and the RE 30 are being operated, the timing adjustment process is preferably executed when the communication traffic is low. In this manner, it is possible to reduce the impact on mobile station communication.

In the embodiment described above, in the timing adjustment process, the control unit 36 of the RE 30 continuously transmits the uplink frame, even if a downlink synchronization loss is detected, because the REC 20 has changed the transmission timing of the downlink frame. However, the disclosed technology is not limited thereto. For example, in the timing adjustment process, if a downlink synchronization loss is detected, the control unit 36 stops transmitting the uplink frame until the resynchronization of the downlink is established. However, the control unit 36 may maintain the transmission timing of the uplink frame. For example, the control unit 36 causes the transmission SERDES 33 to continuously generate the uplink frame, by synchronizing with the transmission timing of the uplink frame before the downlink synchronization loss is detected, until resynchronization of the downlink is established. However, the control unit 36 causes the transmission SERDES 33 to stop transmitting the generated uplink frame. Consequently, the transmission of the uplink frame from the RE 30 to the REC 20 will be stopped, until the resynchronization of the downlink is established.

According to an aspect of the disclosure, it is possible to reduce the time for adjusting the timing between a wireless control device and a wireless device.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission system, comprising:
a wireless control device; and
a wireless device that is connected to the wireless control device through a cable,
the wireless control device including:
a first transmission unit that transmits a downlink frame through the cable in a downlink from the wireless control device to the wireless device,
a first reception unit that receives an uplink frame from the wireless device through the cable in an uplink from the wireless device to the wireless control device, and
an adjustment unit that adjusts a transmission timing of the downlink frame to be transmitted from the first transmission unit so that the transmission timing of the downlink frame from an antenna of the wireless device becomes a predetermined timing after synchronization of the downlink and the uplink is established with the wireless device,
the wireless device including:
a second reception unit that receives the downlink frame from the wireless control device through the cable in the downlink,
a second transmission unit that transmits the uplink frame to the wireless control device through the cable in the uplink, and
a control unit that causes the second transmission unit to start transmitting the uplink frame after the synchronization of the downlink is established with the wireless control device, wherein
after causing the second transmission unit to start transmitting the uplink frame, the control unit of the wireless device causes the second transmission unit to maintain a transmission timing of the uplink frame, even when a synchronization loss of the downlink is detected due to adjustment of the transmission timing of the downlink frame.

2. The transmission system according to claim 1, wherein
the second transmission unit transmits a signal corresponding to the downlink frame having been received by the second reception unit to the wireless control device through the cable, at a timing delayed by a predetermined first time, as the uplink frame, after the synchronization of the downlink is established with the wireless control device, and
the control unit causes the second transmission unit to continuously transmit the uplink frame, at a timing same as the transmission timing of the uplink frame that has been transmitted until the synchronization loss of the downlink is detected, when the synchronization loss of the downlink is detected.

3. The transmission system according to claim 2, wherein
the wireless device further includes a measurement unit that measures a second time that is a time difference between a timing when the second reception unit receives the downlink frame after synchronization of the downlink is established again and a transmission timing of the uplink frame having been continuously transmitted by the second transmission unit, when the synchronization of the downlink is established again after the synchronization loss of the downlink is detected, and
the adjustment unit estimates the second time that is measured in the wireless device after the transmission timing of the downlink frame is changed, determines that adjustment of the transmission timing of the downlink frame has completed when a difference between the second time being estimated and the second time being measured by the measurement unit is less than a predetermined threshold, and changes the transmission timing of the downlink frame again based on the second time being measured by the measurement unit when the difference between the second time being estimated and the second time being measured by the measurement unit is equal to or more than the predetermined threshold.

4. The transmission system according to claim 3, wherein the control unit changes the transmission timing of the uplink frame to be transmitted from the second transmission unit to a timing at which the first time has passed from when the second reception unit receives the downlink frame, when the second time measured by the measurement unit is longer than a third time.

5. The transmission system according to claim 1, wherein the control unit causes the second transmission unit to stop transmitting the uplink frame when resynchronization of the downlink frame is not established until time which is equal to or more than a fourth time has passed from when the synchronization loss of the downlink is detected.

6. A wireless device, comprising:
a reception unit that receives a downlink frame from a wireless control device through a cable in a downlink from the wireless control device to the wireless device;
a transmission unit that transmits an uplink frame to the wireless control device through the cable in an uplink from the wireless device to the wireless control device, and
a control unit that causes the transmission unit to start transmitting the uplink frame to the wireless control device through the cable after synchronization of the downlink is established with the wireless control device, wherein
after causing the transmission unit to start transmitting the uplink frame, the control unit causes the transmission unit to maintain a transmission timing of the uplink frame, even when a synchronization loss of the downlink is detected because the wireless control device has adjusted a transmission timing of the downlink frame.

7. A synchronization establishment method for a transmission system that includes a wireless control device and a wireless device connected to the wireless control device through a cable; the synchronization establishment method comprising:
transmitting a downlink frame to the wireless device through the cable in a downlink from the wireless control device to the wireless device, using the wireless control device;
receiving an uplink frame from the wireless device through the cable in an uplink from the wireless device to the wireless control device, using the wireless control device;
adjusting a transmission timing of the downlink frame to be transmitted from the wireless control device so that the transmission timing of the downlink frame from an antenna of the wireless device becomes a predetermined timing after synchronization of the downlink and the uplink is established with the wireless device, using the wireless control device;
receiving the downlink frame from the wireless control device through the cable in the downlink, using the wireless device;
starting transmission of the uplink frame to the wireless control device through the cable in the uplink after synchronization of the downlink is established with the wireless control device, using the wireless device; and
maintaining, after the transmission of the uplink frame has started, a transmission timing of the uplink frame, even when a synchronization loss of the downlink is detected due to adjustment of the transmission timing of the downlink frame, using the wireless device.
